(19) United States
(12) Patent Application Publication
(10) Pub. No.: US 2006/0011851 A1
(43) Pub. Date: Jan. 19, 2006

(54) Component carrier for at least one x-ray sensitive detector element and detector for an imaging x-ray device

(76) Inventors: Ludwig Danzer, Wendelstein (DE); Richard Matz, Bruckmuehl (DE)

Correspondence Address: HARNESS, DICKEY & PIERCE, P.L.C., P.O.BOX 8910, RESTON, VA, 20195, US

(21) Appl. No.: 11/171,245

(22) Filed: Jul. 1, 2005

(30) Foreign Application Priority Data
Jul. 2, 2004 (DE) 10 2004 032 224.4

(51) Int. Cl. G01T 1/24

(52) U.S. Cl. 250/370.09

(57) ABSTRACT

A component carrier is for at least one x-ray sensitive detector element. On the carrier, at least one signal-processing component can be arranged. The carrier includes an x-ray absorbing material for the protection of the signal-processing component from x-rays.

The present application hereby claims priority under 35 U.S.C. §119 on German patent application number DE 10 2004 032 224.4 filed Jul. 2, 2004, the entire contents of which is hereby incorporated herein by reference.

### FIELD

The invention generally relates to a component carrier for at least one x-ray sensitive detector element, for example a carrier on which at least one signal-processing component can be arranged. The invention also generally relates to a detector for an imaging x-ray device.

### BACKGROUND

Component carriers and detectors of this type with at least one signal-processing component are used for example for x-ray devices in which a plurality of detector elements are arranged on the side of the component carrier that is facing the x-rays and in which the output signals generated by the detector elements are processed by signal-processing components arranged alongside the detector elements.

The signal-processing components arranged on the component carrier are susceptible to interference by x-radiation. A signal-processing component of a detector that is exposed to x-radiation sometimes supplies an output signal that is affected by interference, which can lead to an impairment of the achievable image quality of a radiograph. In an extreme case, such a component may even be damaged or destroyed completely.

On the other hand, in the interests of shortest possible signal paths, the signal-processing components should be arranged as close as possible to the detector array affected by the x-radiation. For this reason, the signal-processing components are usually positioned directly alongside the detector array, but outside the detection field covered by the x-radiation. Although in this position the signal-processing components are not normally exposed to direct x-radiation, these components must nevertheless be protected by additional measures from secondary, stray x-radiation, which laterally emanates from the elements at the edge of the detector array.

DE 100 51 162 A1 discloses a detector in which a scintillator of a detector element arranged at the edge of the detector field is in each case additionally extended perpendicularly to the line of the edge, so that a region of the scintillator lies outside the detection field. The region of the scintillator lying outside the detection field serves for absorbing the stray x-radiation produced by the primary x-radiation, so that the signal-processing components adjacent the detector array are largely protected from the indirect incidence of x-radiation.

A certain protection of the signal-processing components with respect to x-radiation can also be achieved by corresponding measures during the design phase and during the production process of these components. This procedure is also referred to in the literature as spectral hardening of the signal-processing elements. The expenditure and costs involved in hardening these components are dependent in particular on the intensity of the x-radiation that is incident on a component. In the interests of low production costs of these components, there is a need for additional measures which make it possible to reduce the x-radiation radiating onto the signal-processing component.

### SUMMARY

An object of an embodiment of the present invention is to design a component carrier or a detector in such a way that signal-processing components, which can be arranged on the component carrier, are at least partly protected from x-radiation in a simple way.

This object may be achieved by a component carrier.

The object may also be achieved by a detector.

According to an embodiment of the invention, the component carrier may have an x-ray absorbing material.

Such a component carrier according to an embodiment of the invention allows the signal-processing components to be protected against incident x-radiation when they are appropriately positioned, so that, dependent on the degree of absorption of the incident x-radiation, the costs for corresponding spectral hardening of these components during the design and production process can be lowered considerably or, in the case of complete absorption of the incident x-radiation, can be eliminated entirely.

A component carrier according to an embodiment of the invention additionally makes it possible to position signal-processing components directly in the vicinity of signal-generating components, such as for example detector elements of a detector for an x-ray device, which can be used for generating detector output signals as a measure of the absorption of radiation passing through a measuring region, so that the associated short signal paths ensure interference-free signal transmission between the components.

Positioning of detector elements and signal-processing components a small distance from one another that can be carried out by the component carrier according to an embodiment of the invention additionally has the advantage that the detector can be realized in a much smaller overall volume, since it dispenses with the additional region outside the detection field in which the signal-processing components are usually positioned.

In an advantageous refinement of an embodiment of the invention, the component carrier, which may also be referred to as a substrate, is an x-ray absorbing material in the form of lead glass, which may for example be added to a ceramic-based basic material of a component carrier as an admixture. The degree of absorption of incident x-radiation can in this case be determined in a simple way by the amount of lead glass that is admixed.

To protect the signal-processing components extended over a certain region, the x-ray absorbing material of at least one embodiment may advantageously have at least a partly sheet-like extent. Additional cost advantages may arise through material savings as a result of the x-ray absorbing material having an extent that extends only over a necessary subregion of the component carrier.

The component carrier according to an embodiment of the invention can then be produced particularly simply if the component carrier has a layer of the x-ray absorbing material. In the case of such a component carrier it is possible to use commercially available component carriers that are merely modified by a layer of the x-ray absorbing material that can easily be introduced or applied. For example, the layer may be adhesively attached or else vapor-deposited in a simple production process.

In addition, the degree of attenuation can be fixed in a particularly simple manner by the layer thickness.

In the case of a component carrier according to an embodiment of the invention, the x-ray absorbing layer may then be assigned to the side facing the x-rays if the contacting of signal-processing components on the correspondingly opposite side of the component carrier is more complex, since in this case correspondingly fewer contacts have to be led through the x-ray absorbing layer. Conversely, in the case of correspondingly more complex contacting of the components on the side of the component carrier that is facing the x-rays, the x-ray absorbing layer is advantageously assigned to the side of the component carrier that is facing away from the x-rays. If no contacting between the components is envisaged on either side of the component carrier in the region of the incident x-radiation, the x-ray absorbing layer can be arranged particularly advantageously inside the component carrier.

In a further advantageous refinement, the at least one detector element, which serves for generating detector output signals which are a measure of the absorption of the x-radiation passing through a measuring region, is arranged on the side facing the x-rays.

An advantageous arrangement of at least one signal-processing component on the side of the component carrier that is facing away from the x-rays makes it possible in particular in the case of detectors for x-ray devices to obtain a compact type of construction of detector elements and signal-processing components in which the overall volume is reduced in comparison with conventional detectors, the detector elements and the signal-processing components being arranged such that they are lying opposite on the component carrier and are connected to one another so as to obtain short signal paths.

An object may also be achieved by a detector with a component carrier of the detector having an x-ray absorbing material for the protection of at least one signal-processing component from x-rays. The detector may include, for example, a number of detector modules arranged alongside one another. Each detector module may advantageously include an array of detector elements.

### BRIEF DESCRIPTION OF THE DRAWINGS

Example embodiments of the invention and further advantageous refinements of the invention are represented in the following schematic drawings, in which:

FIG. 1 shows a lateral view of a component carrier according to an embodiment of the invention for a detector of an imaging x-ray device with signal-processing components and detector elements arranged on the carrier,

FIG. 2 shows an enlarged detail of the left-hand edge of the component carrier from FIG. 1,

FIG. 3 shows the detail of the component carrier from FIG. 2, but with a layer of the x-ray absorbing material on the side of the component carrier that is facing the x-rays,

FIG. 4 shows the detail of the component carrier from FIG. 3, but with a layer of the x-ray absorbing material on the side of the component carrier that is facing away from the x-rays,

FIG. 5 shows the detail of the component carrier from FIG. 3, but with a layer of the x-ray absorbing material inside the component carrier,

FIG. 6 shows a component carrier according to an embodiment of the invention with detector elements and signal-processing components arranged such that they are lying opposite,

FIG. 7 shows a plan view of a detector for an imaging x-ray device, having a number of detector modules arranged alongside one another with a component carrier, which contains an x-ray absorbing material.

### DETAILED DESCRIPTION OF THE EXAMPLE EMBODIMENTS

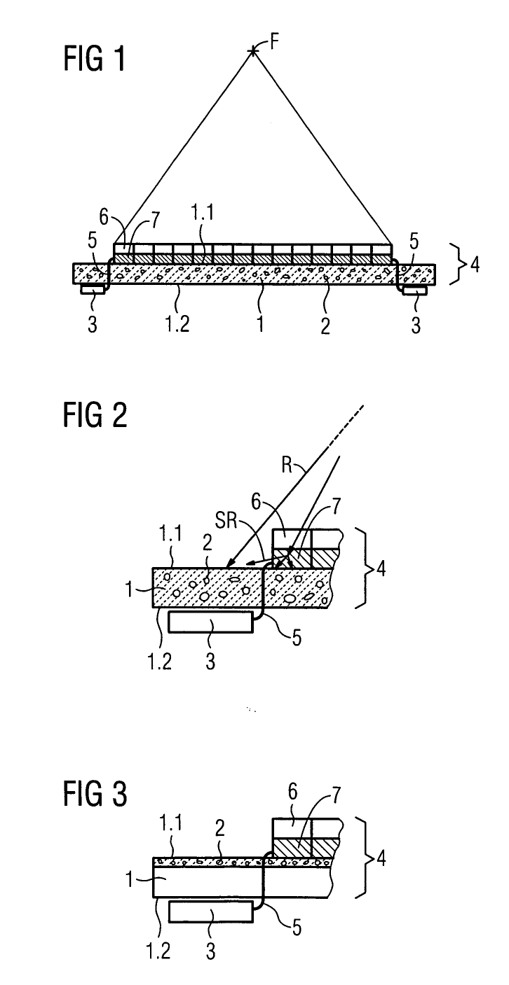

FIG. 1 shows a lateral view of a component carrier 1 according to an embodiment of the invention with an x-ray absorbing material 2 in the form of lead glass for a detector 4 of an imaging x-ray device, in particular a computer tomography device, an array of detector elements 6, 7 for generating detector output signals being arranged on the side 1.1 of the component carrier 1 that is facing the x-rays and a plurality of signal-processing elements 3 being arranged on the side 1.2 facing away from the x-rays, for processing the generated detector output signals. For reasons of overall clarity, not every detector element is provided with a designation.

The detector elements 6, 7 respectively have a scintillator 6 and a photodiode 7. However, other detector elements can also be used, such as for example so-called gas detectors, in which a gas that is under high pressure from a material with a high atomic number performs the absorption of the x-ray photons and consequently makes possible the direct conversion into electric charge carriers. The detector output signals generated by the respective detector element 6, 7 serve in this case as a measure of the absorption of the x-radiation emanating from a focal point F and passing through a measuring region and are processed by the signal-processing components 3 arranged on the side 1.2 of the component carrier 1 that is facing away from the x-rays. The respective detector element 6, 7 is connected to the respective signal-processing component 3 via bonding wires 5 so as to obtain the shortest possible signal path, the bonding wires 5 being led through the component carrier 1 in the case of the present example embodiment.

FIG. 2 shows an enlarged detail of the left-hand edge of the component carrier 1 according to an embodiment of the invention shown in FIG. 1. In the case of complete illumination of the detection field formed by the detector elements 6, 7, it is possible for fitting tolerances to cause a situation in which the primary x-radiation emanating from the focal point F impinges directly, as indicated by a dashed first arrow R, on the region of the component carrier 1 adjacent the detector field. In addition, as indicated by a second arrow SR, this region of the component carrier 1 is additionally exposed to stray x-radiation, which emanates from the respective scintillator 6 arranged at the edge of the detection field. On account of the x-ray absorbing material 2 provided in the component carrier 1, the two x-rays of different origin are attenuated, preferably completely absorbed, in the region of the component carrier 1 lying over the signal-processing component 3, so that the signal-processing component 3 is reliably protected from incident x-radiation.

The protection of the signal-processing component 3 from x-radiation that can be achieved by way of the component carrier 1 according to an embodiment of the invention allows the expenditure for a costly spectral hardening of the components to be lowered considerably. For the case of complete absorption of x-radiation by the component carrier 1, conventional signal-processing components can be used for a detector 4, so that the costs for corresponding spectral hardening of the components can even be eliminated entirely.

The degree of absorption of the x-rays passing through the component carrier 1 can be predetermined in a simple way by the amount of x-ray absorbing material 2, for example lead glass, that is additionally added to the basic material, for example ceramic, of the component carrier 1. In this way, use of the component carrier 1 according to an embodiment of the invention makes it possible to dispense with a modification of the detector elements arranged at the edge for the absorption of the stray radiation or to dispense with the fitting of additional components for protection from primary x-radiation impinging laterally on the detection field.

FIG. 3 shows a detail of another component carrier 1 according to an embodiment of the invention, which substantially corresponds to the detail shown in FIG. 2, but with the difference that the x-ray absorbing material 2 is in the form of a layer 8, which is arranged on the side 1.1 of the component carrier 1 that is facing the x-rays. A component carrier 1 of this configuration can be produced in a particularly simple way, for example by adhesively attaching or vapor-depositing the x-ray absorbing layer 8 on the basic material of the component carrier 1. The thickness of the adhesively attached layer 8 thereby determines the degree of absorption of x-rays.

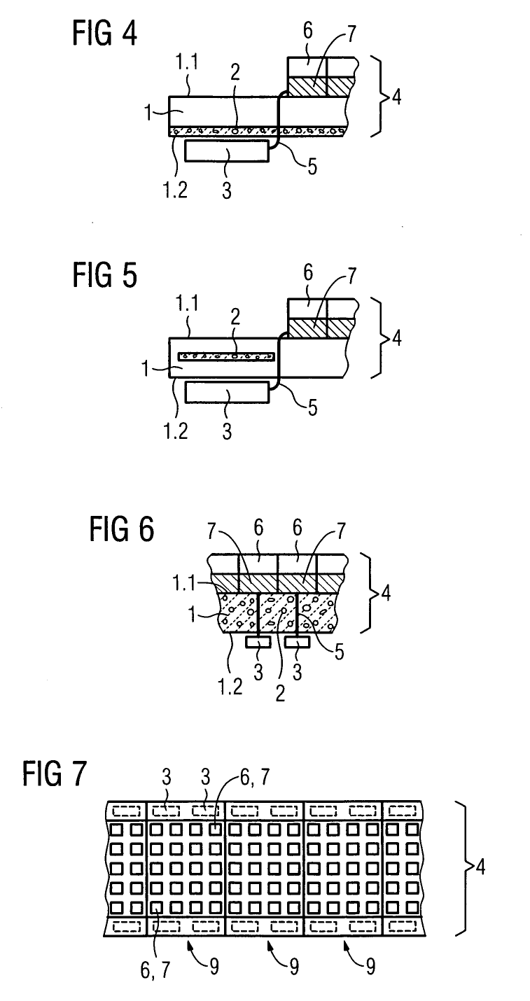

FIG. 4 shows a detail of a further component carrier 1 according to an embodiment of the invention, the x-ray absorbing material 2 being configured as a layer 8, which however is arranged on the side 1.2 of the component carrier 1 that is facing away from the x-rays. A component carrier 1 of this configuration is particularly advantageous if a smaller number of components has to be contacted on the side 1.2 of the component carrier 1 that is facing away from the x-rays in comparison with the facing side 1.1. In this case it is necessary for a smaller number of signal lines to be led through the x-ray absorbing layer 8, a procedure that involves a certain expenditure.

In FIG. 5, a further example embodiment of a component carrier 1 according-to an embodiment of the invention is shown in a detail represented according to FIG. 4, the x-ray absorbing layer 8 being arranged inside the component carrier and the layer 8 extending in a sheet-like manner substantially only over the region of the extent of the signal-processing component 3. A layer 8 of the x-ray absorbing material 2 that advantageously extends only over a subregion has an associated cost advantage, on account of material savings, while at the same time ensuring the protection of the signal-processing component 3 with respect to x-radiation. In addition, in the case of an extent of the layer 8 that is delimited in a sheet-like form, the signal lines between the respective detector element 6, 7 and the respective signal-processing components 3 can be routed in such a way that no bores have to be made through the layer 8.

FIG. 6 shows an embodiment of the component carrier 1 according to an embodiment of the invention in a detail of a side view with the detector element 6, 7 and the signal-processing component 3 respectively arranged such that they are lying opposite. The respective signal-processing component 3 is reliably protected from x-radiation by the x-ray absorbing material 2 provided in the component carrier 1. In the case of such an arrangement, on the one hand very short signal paths between the detector element 6, 7 and the signal-processing component 3 can be ensured in particular and on the other hand the construction of a detector 4 with a small overall volume is possible, since it is not necessary, in comparison with conventional detectors, for the respective signal-processing component 3 to be arranged on an additionally provided area alongside the detector elements outside the x-radiation.

FIG. 7 shows the detector 4 according to an embodiment of the invention for an imaging x-ray device from FIG. 1 in a plan view, the detector having a number of detector modules 9 arranged alongside one another. In the present case of the example embodiment, a two-dimensional array of detector elements 6, 7 is arranged on the side 1.1 of the component carrier 1 of the respective detector module 1 that is facing the x-rays. The signal-processing components 3 at the edge of the array are arranged on the side 1.2 correspondingly facing away from the x-rays, for processing the detector output signals of the detector elements 6, 7. For reasons of overall clarity, not every detector element 6, 7 and not every signal-processing component 3 is provided with a designation.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A component carrier for at least one x-ray sensitive detector element, at least one signal-processing component being arrangeable on the component carrier, comprising:
an x-ray absorbing material for protection of the at least one signal-processing component from x-rays.

2. The component carrier as claimed in claim 1, wherein the component carrier includes an x-ray absorbing material in the form of lead glass.

3. The component carrier as claimed in claim 1, wherein the x-ray absorbing material includes at least a partly sheet-like extent.

4. The component carrier as claimed in claim 1, wherein the component carrier includes at least one layer of the x-ray absorbing material.

5. The component carrier as claimed in claim 4, wherein the layer of the x-ray absorbing material is assigned to a side of the component carrier that is facing the x-rays.

6. The component carrier as claimed in claim 4, wherein the layer of the x-ray absorbing material is assigned to a side of the component carrier that is facing away from the x-rays.

7. The component carrier as claimed in claim 4, wherein the layer of the x-ray absorbing material is arranged inside the component carrier.

8. The component carrier as claimed in claim 1, wherein the at least one x-ray sensitive detector element is arranged on a side of the component carrier that is facing the x-rays.

9. The component carrier as claimed in claim 1, wherein at least one signal-processing component is arranged on a side facing away from the x-rays.

10. A detector for an imaging x-ray device, including a component carrier as claimed in claim 1.

11. The detector as claimed in claim 10, comprising at least one detector module.

12. The component carrier as claimed in claim 2, wherein the x-ray absorbing material includes at least a partly sheet-like extent.

13. The component carrier as claimed in claim 2, wherein the component carrier includes at least one layer of the x-ray absorbing material.

14. The component carrier as claimed in claim 3, wherein the component carrier includes at least one layer of the x-ray absorbing material.

15. The component carrier as claimed in claim 5, wherein the layer of the x-ray absorbing material is assigned to a side of the component carrier that is facing away from the x-rays.

16. A detector for an imaging x-ray device, including a component carrier as claimed in claim 2.

17. The detector as claimed in claim 16, comprising at least one detector module.
